(19) United States
(12) Patent Application Publication
(10) Pub. No.: US 2012/0161601 A1
(43) Pub. Date: Jun. 28, 2012

(54) BULB-TYPE LED LAMP AND HEAT DISSIPATION STRUCTURE THEREOF

(75) Inventor: Chyi-Lang LAI, Wu-Ku Industrial Park (TW)

(73) Assignee: Chicony Power Technology Co., Ltd.

(21) Appl. No.: 12/975,523

(22) Filed: Dec. 22, 2010

(51) Int. Cl. F21V 29/00; F28F 13/00

(52) U.S. Cl. 313/45; 165/80.3

(57) ABSTRACT

The LED lamp of the invention includes a base, a heat dissipation assembly and a circuit board. The heat dissipation assembly has a cylindrical casing. Two ends of the casing are formed with a tube connecting the base and a mount portion, respectively. The casing is provided with radial fins which extend from the mount portion but do not connect with the tube. Slots are formed between the fins and the casing. The circuit board which is mounted by LEDs is fastened on one end of the heat dissipation assembly.

### BACKGROUND OF THE INVENTION

1. Technical Field

The invention relates to LED lamps, particularly to heat dissipation of LED lamps.

2. Related Art

Light emitting diodes (LEDs) has been replacing conventional lamps on the strength of small volume, low energy consumption and low pollution. LED tubes and bulbs have been popular in the market.

With the advance of performance of the LEDs, many LED bulbs with E27 and E17 bases also appear in the market for replacing conventional incandescent bulbs and compact fluorescent lamps. A typical LED bulb 1a is shown in FIG. 1. Because the high power LED 10a used in the LED bulb la generates a large amount of heat when it is working, a plurality of fins 20a must be disposed on the casing. In order to enlarge the area of heat dissipation, usually the length of the fins 20a is formed to be substantially the same as or even larger than that of casing 30a. However, such fins 20a are disadvantageous to air convection. That is, heat transfer only appears on the surface of the fins 20a without air convection.

### SUMMARY OF THE INVENTION

An object of the invention is to provide a bulb-type LED lamp which can increase the space of air convection and introduce more air to improve the efficiency of heat dissipation.

Another object of the invention is to provide a heat dissipation structure of a bulb-type LED lamp, which has air passages formed by the shortened and slotted fins to form air convection so as to improve the efficiency of heat dissipation.

To accomplish the above objects, the LED lamp of the invention includes a base, a heat dissipation assembly and a circuit board. The heat dissipation assembly has a cylindrical casing. Two ends of the casing are formed with a tube connecting the base and a mount portion, respectively. The casing is provided with radial fins which extend from the mount portion but do not connect with the tube. Slots are formed between the fins and the casing. The circuit board which is mounted by LEDs is fastened on one end of the heat dissipation assembly.

### BRIEF DESCRIPTION OF THE DRAWINGS

FIG. 1 is a longitudinal sectional view of a conventional LED light bulb;

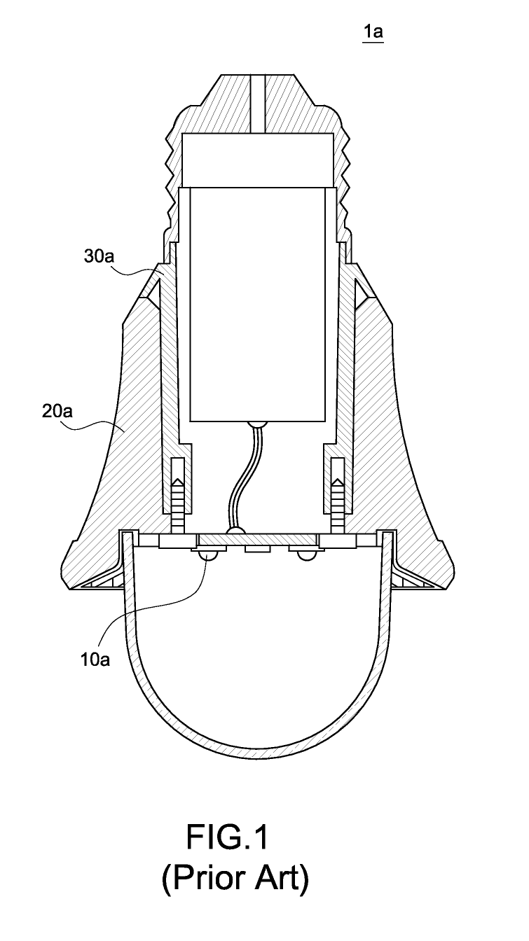

FIG. 2 is an exploded view of the invention;

FIG. 3 is an exploded view of the invention in another view angle;

FIG. 4 is an assembled view of the invention;

FIG. 5 is a longitudinal sectional view of the invention;

FIG. 6 is a schematic view showing the status of air convection of the invention; and

FIG. 7 is a perspective view of another embodiment of the invention.

### DETAILED DESCRIPTION OF THE INVENTION

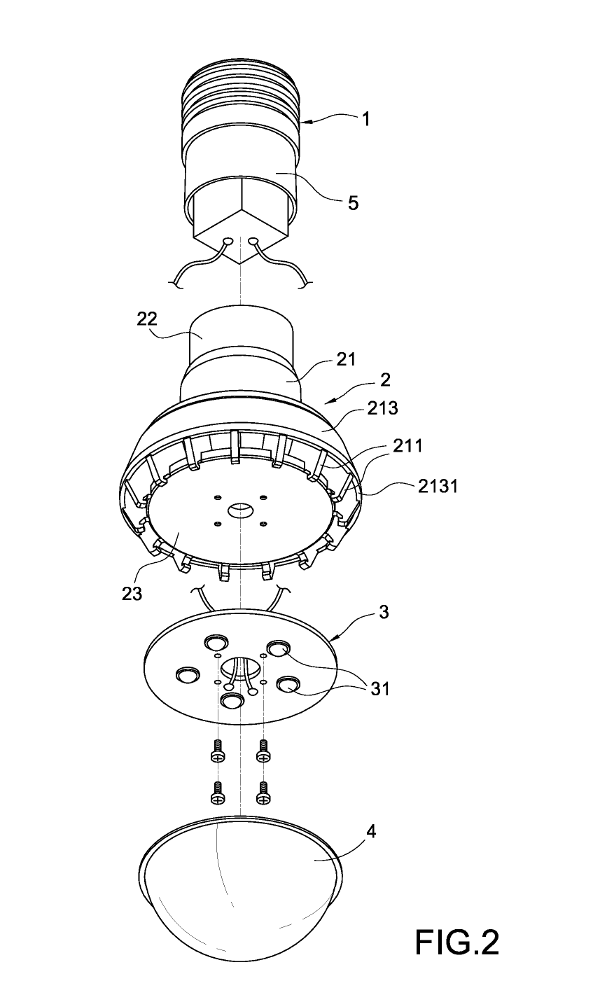

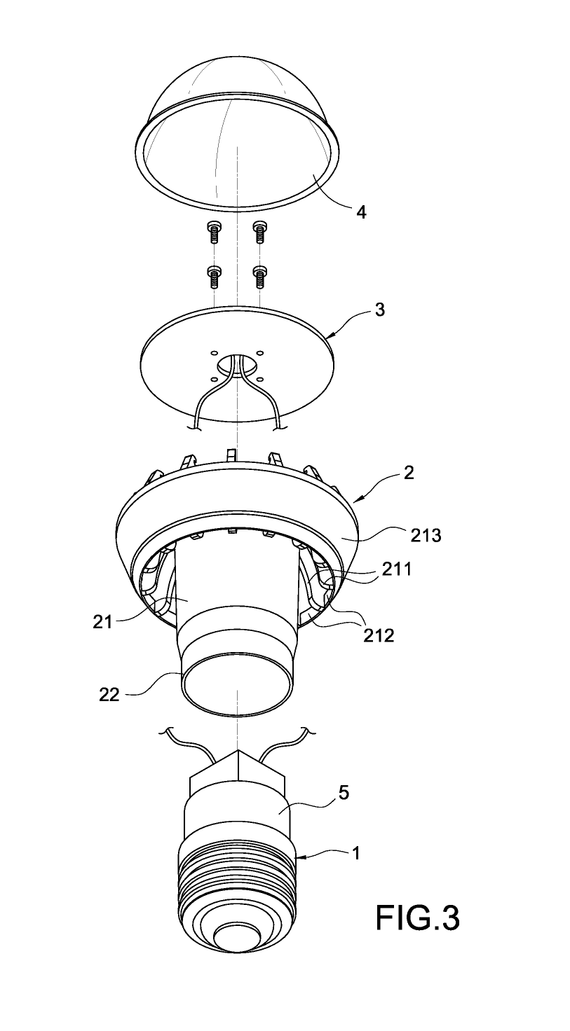

Please refer to FIGS. 2 and 3. The bulb-type LED lamp includes a base 1, a heat dissipation assembly 2, a circuit board 3, a cover 4 and an insulation 5.

The heat dissipation assembly 2 has a cylindrical casing 22. Two ends of the casing 22 are formed with a tube 22 connecting the base 1 and a mount portion 23, respectively. The casing 21 is provided with radial fins 211 which extend from the mount portion 23 but do not connect with the tube 22. Preferably, the fins 211 are not larger than two thirds of the casing 21 in length to prevent air convection from resisting. Besides, the amount of the fins 211 depends on the size of the heat dissipation assembly 2. Additionally, if the fins 211 are too congested, it will resist air convection; while if the fins 211 are too dispersive, it will reduce heat conduction. Thus the distance of two adjacent fins 211 is preferably, but not limited to, from 5 mm to 15 mm.

A slot 212 is formed between each the fin 211 and the casing 21. Only a small part of the fin 211 is in contact with the casing 21. That is, the fins 211 outwards and aslant extend from the mount portion 23 to increasingly enlarge the slots 212 in size. This can increase the space of air convection for allowing air to flow among the fins 211. Additionally, a ring 213 is disposed around the fins 211. The ring 213 encompasses and connects the fins 211. The bottom edge 2131 of the ring 213 is separate from the mount portion 23 to form an air passage. In this embodiment, the thickness of the ring 213 is at least 1 mm. The circuit board 3 is fastened on the bottom of the casing 21. There are LEDs mounted on the circuit board 3. The insulation 5 is disposed between the base 1 and tube 22 for insulating the both.

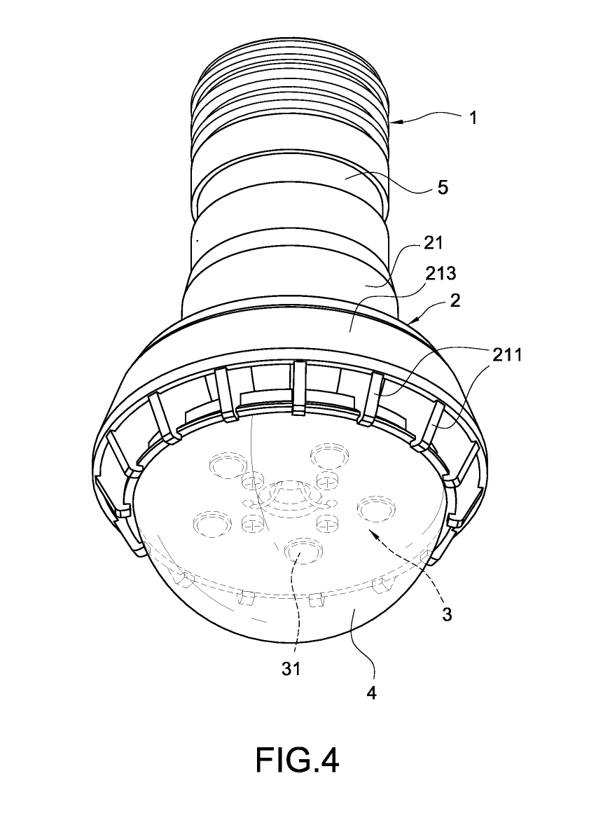

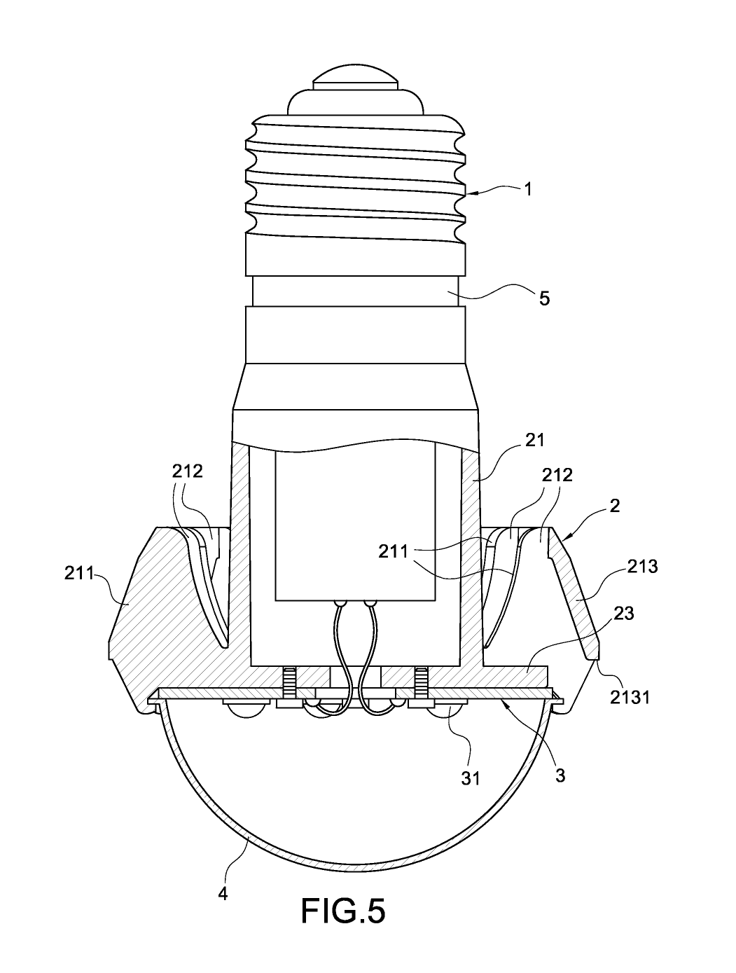

Please refer to FIGS. 4 and 5. The circuit board 3 is on one end of the heat dissipation assembly 2. The top of the heat dissipation assembly 2 connects to the base 1 to make an electric connection. The cover 4 made of transparent or translucent material is assembled with the heat dissipation assembly 2 to cloak the circuit board 3. And the fins 211 are arranged radially.

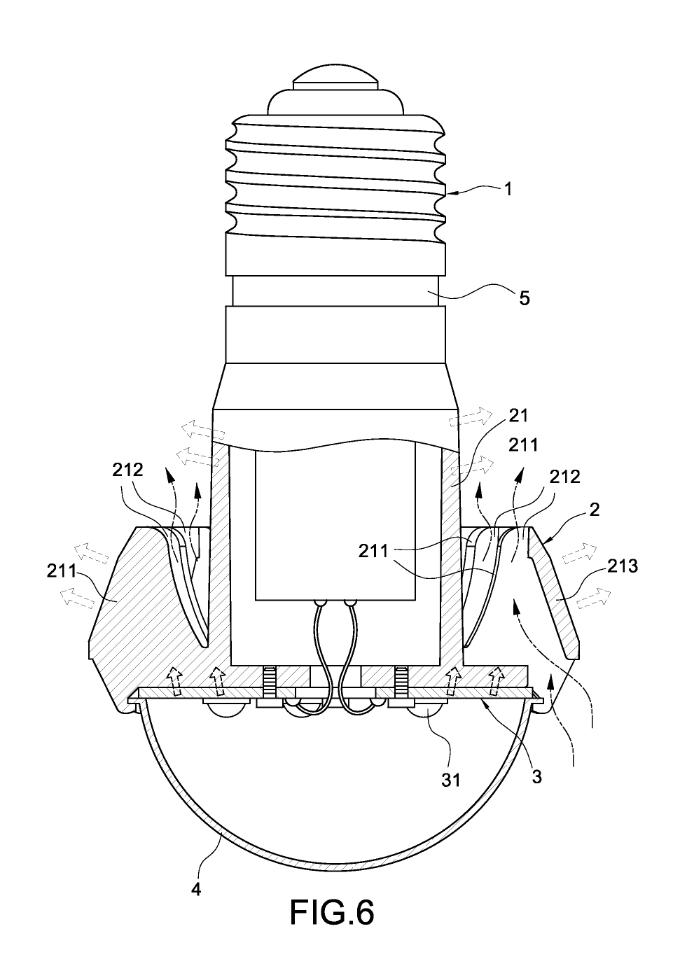

FIG. 6 illustrates the status of air convection of the invention. Due to the direct connection between the circuit board 3 and the casing 21 of the heat dissipation assembly 2, the heat from the LEDs 31 will be conducted to the casing 21, fins 21 and ring 213. This is heat dissipation by means of heat conduction. On the other hand, external air may also flow among the fins 211. Air flows not only among the fins 211 but also transversely through the slots 212. Thus the invention can improve the performance of heat dissipation by means of both air convection and heat conduction.

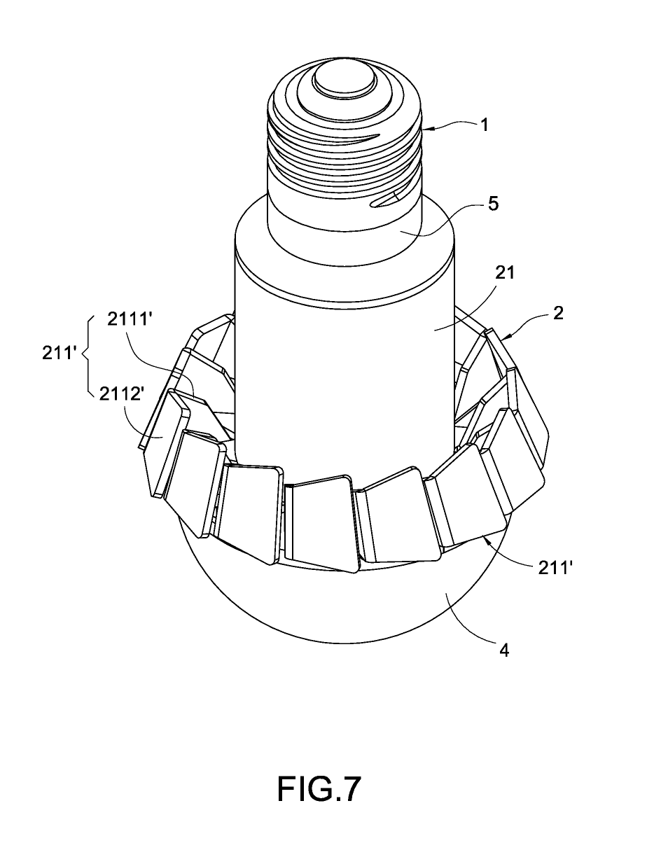

FIG. 7 shows another embodiment of the invention. The fins 211′ are formed into an L shape. Each of the fins 211′ is composed of a longitudinal section 2111′ extending from the casing 21 and a transverse section 2112′ connecting the longitudinal section 2111′. One of the longitudinal sections 2111′ is next to one of the transverse sections 2112′. The bottoms of the transverse sections 2112′ are separate from the mount portion 23 to form an air passage. The fins 211′ are not larger than two thirds of the casing 21 in length.

While the forgoing is directed to preferred embodiments of the present invention, other and further embodiments of the invention may be devised without departing from the basic scope thereof. As such, the appropriate scope of the invention is to be determined according to the claims.

What is claimed is:

1. A bulb-type LED lamp comprising:
a base,
a heat dissipation assembly, having a cylindrical casing, two ends of the casing being formed with a tube connecting the base and a mount portion respectively, the casing being provided with radial fins which extend from the mount portion but do not connect with the tube, and slots being formed between the fins and the casing; and
a circuit board, mounted by a light emitting diode (LED), and fastened on the mount portion.

2. The bulb-type LED lamp of claim 1, wherein the fins are not larger than two thirds of the casing in length.

3. The bulb-type LED lamp of claim 1, wherein the fins are formed into an L shape, each of the fins is composed of a longitudinal section extending from the casing and a transverse section connecting the longitudinal section, one of the longitudinal sections is next to adjacent one of the transverse sections, and bottoms of the transverse sections are separate from the mount portion to form an air passage.

4. The bulb-type LED lamp of claim 1, wherein a ring is disposed around the fins, the ring encompasses and connects the fins, and a bottom edge of the ring is separate from the mount portion to form an air passage.

5. The bulb-type LED lamp of claim 4, wherein a thickness of the ring is at least 1 mm.

6. The bulb-type LED lamp of claim 1, wherein a distance of two adjacent fins is from 5 mm to 15 mm.

7. The bulb-type LED lamp of claim 1, wherein the fins outwards and aslant extend from the mount portion to increasingly enlarge the slots in size.

8. A heat dissipation structure of LED lamp, comprising a heat dissipation assembly, having a cylindrical casing, two ends of the casing being formed with a tube and a mount portion respectively, the casing being provided with radial fins which extend from the mount portion but do not connect with the tube, and slots being formed between the fins and the casing.

9. The heat dissipation structure of LED lamp of claim 8, wherein the fins are not larger than two thirds of the casing in length.

10. The heat dissipation structure of LED lamp of claim 8, wherein the fins are formed into an L shape, each of the fins is composed of a longitudinal section extending from the casing and a transverse section connecting the longitudinal section, one of the longitudinal sections is next to adjacent one of the transverse sections, and bottoms of the transverse sections are separate from the mount portion to form an air passage.

11. The heat dissipation structure of LED lamp of claim 8, wherein a ring is disposed around the fins, the ring encompasses and connects the fins, and a bottom edge of the ring is separate from the mount portion to form an air passage.

12. The heat dissipation structure of LED lamp of claim 11, wherein a thickness of the ring is at least 1 mm.

13. The heat dissipation structure of LED lamp of claim 8, wherein a distance of two adjacent fins is from 5 mm to 15 mm.

14. The heat dissipation structure of LED lamp of claim 8, wherein the fins outwards and aslant extend from the mount portion to increasingly enlarge the slots in size.
